(19) United States
(12) Patent Application Publication
(10) Pub. No.: US 2020/0411204 A1
(43) Pub. Date: Dec. 31, 2020

(54) EMERGENCY COOLING WATER SYSTEM FOR A FLOATING NUCLEAR REACTOR

(71) Applicant: PALVANNANATHAN GANESAN, OMAHA, NE (US)

(72) Inventor: PALVANNANATHAN GANESAN, OMAHA, NE (US)

(21) Appl. No.: 16/456,587

(22) Filed: Jun. 28, 2019

(51) Int. Cl. G21C 15/18; G21C 11/04; G21D 3/04

(52) U.S. Cl. CPC G21C 15/182; G21D 3/04; G21C 11/04

(57) ABSTRACT

An emergency cooling water system for a nuclear reactor which is mounted on a barge which floats in a water tank. The nuclear reactor includes an upstanding containment member having an interior compartment. At least one, and preferably two or more, cold water tubes are provided which have inner and outer ends with the outer ends of the cold water tubes being in communication with a source of cold water. The cold water tubes extend through the tank and the barge and have their inner ends in communication with the interior compartment of the nuclear reactor. In an emergency situation, cold water from the source of cold water is fed into the interior compartment of the containment member of the nuclear reactor.

### BACKGROUND OF THE INVENTION

### Field of the Invention

This invention relates to a floating nuclear power reactor. More particularly this invention relates to a floating nuclear power reactor including a barge which is floatably positioned in the interior of a large water-filled tank and wherein the nuclear power reactor is positioned on the barge. The present invention relates to a cold water feeding system which brings cold water directly into the containment space of the reactor in an emergency situation. Even more particularly, the instant invention relates to a cold water feeding system which permits the barge to move with respect to the tank without causing damage to the cold water feeding system.

### Description of the Related Art

Applicant has received U.S. Pat. Nos. 9,378,855; 9,396,823; and 9,502,143 relating to nuclear reactors positioned in a body of water or tank to be able to flood and cool the nuclear reactor with the water in the tank in the event of overheating or over pressurization of the nuclear reactor. Even though the reactor is positioned on a barge which floats in a tank of water, the water in the tank becomes warm due to the heat lost from the reactor by conduction, convention and radiation with the warm water in the tank unable to provide maximum cooling of the reactor in an emergency cooling situation. To the best of Applicant's knowledge, no prior art system is able to supply cold water directly into the confinement space of the reactor during emergency cooling.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A floating nuclear reactor is disclosed. The floating nuclear reactor of this invention includes a tank, which may be rectangular, having a bottom wall, an upstanding first end wall, an upstanding second end wall, an upstanding first side wall and an upstanding second side wall and which may be partially or fully buried in the ground with the tank having water therein. A barge is floatably positioned in the tank with the barge having a bottom wall, a first end wall, a second end wall, a first side wall and a second side wall. A nuclear reactor is positioned on the barge.

The nuclear reactor includes an upstanding containment member having a sealed interior compartment. A reactor vessel is positioned in the sealed interior compartment and has an interior compartment.

At least one water pipe or tube is provided which has an inlet end and an outlet end. The inlet end of the at least one water pipe or tube is positioned outwardly of the water tank and is in fluid communication with a source of cold water. The at least one water pipe or tube extends inwardly through one of the walls of the water tank and extends inwardly through the barge. The outlet end of the at least one water pipe or tube extends through the containment member into the interior compartment of the containment member to supply cold water into the interior compartment of the containment member during emergency cooling situations to cool the reactor vessel. That portion of the at least one water pipe or tube which is positioned between the water tank and the containment member is flexible and slack so that movement of the barge with respect to the water tank will not damage the cold water feeding system. The at least one pipe or tube has a valve and a pump associated therewith outwardly of the tank. The valve and pump may be remotely controlled.

The containment member has a discharge opening formed therein at the upper end thereof which permits warm water in the containment member to flow outwardly therefrom whereby additional cold water may be brought into the containment member by way of the at least one water pipe or tube to maintain the maximum cooling of the cooling loops in the reactor vessel.

It is a principal object of the invention to provide an emergency cooling water system for a floating nuclear reactor.

A further object of the invention is to provide a discharge outlet adjacent to the upper end of the containment member which is positioned above the water level in the water tank so that the level of water in the containment member may be above the water level in the water tank to increase the cooling of the reactor vessel.

A further object of the invention is to provide an emergency cooling water system which includes at least one flexible water pipe or tube which permits the barge to move with respect to the water tank without the flexible water pipe or tube breaking.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a nuclear reactor floating in a water tank;

FIG. 2 is a perspective view similar to FIG. 1 except that a roof structure is positioned over the nuclear reactor and the barge;

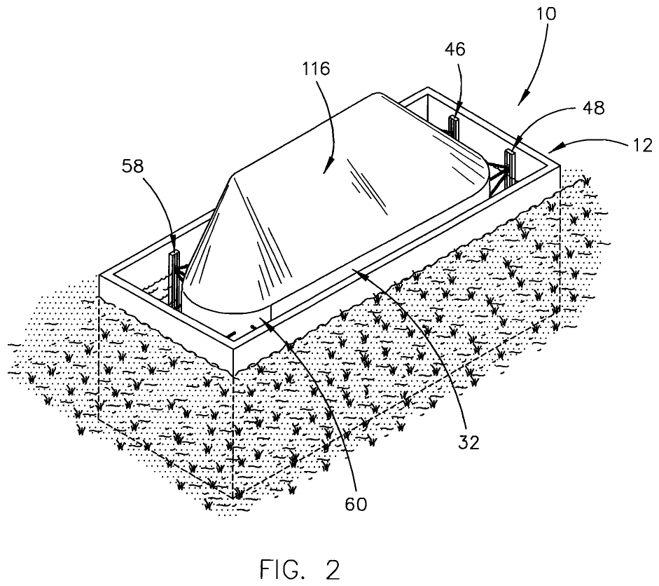

FIG. 3 is a top sectional view of the floating nuclear reactor of this invention;

FIG. 4 is a sectional view of the floating nuclear reactor and which illustrates the emergency cooling water system for the floating nuclear reactor of FIGS. 1-3 prior to the need for cooling water; and

FIG. 5 is a sectional view similar to FIG. 4 except that cooling water has been fed to the containment member of the nuclear reactor.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

Applicant has previously received U.S. Pat. Nos. 9,378,855; 9,396,823; and 9,502,143 relating to floating nuclear power reactors. Applicant incorporates the disclosure of the above identified patents in their entirety by reference thereto to complete this disclosure if necessary.

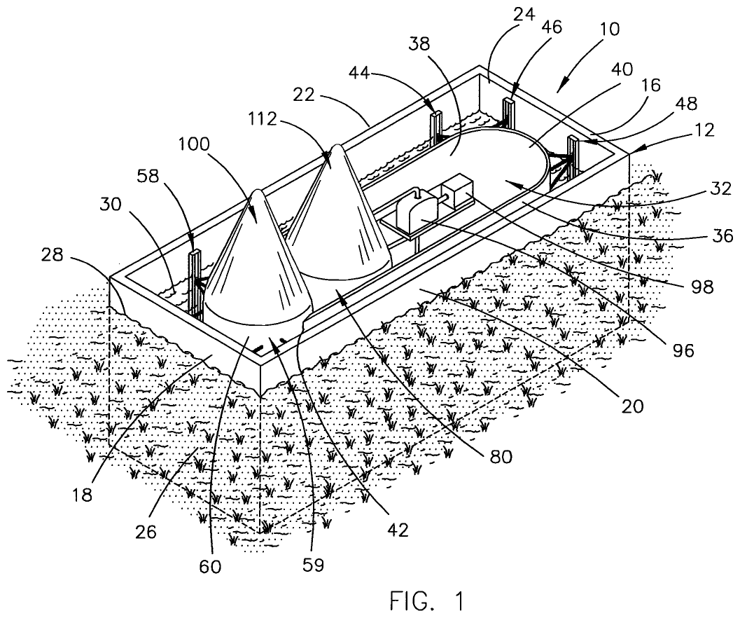

The emergency cooling water system of this invention is designed for use with a floating nuclear reactor which is referred to generally by the reference numeral 10. The emergency cooling water system of this invention will be described in detail hereinafter. The nuclear reactor 10 floats in a concrete tank 12 having a bottom wall 14, a first end wall 16, a second end wall 18, a first side wall 20, a second side wall 22 and an open upper end 24. Tank 12 is buried in the ground 26 as seen in FIG. 1 so that the open upper end 24 of tank 12 is at or above ground level 28. The tank 12 is partially filled with water 30 from a source of water. Preferably the water 30 is gravity fed to the tank 12. The tank 12 may be completely buried in the ground. The tank 12 may have other shapes.

The numeral 32 refers to a barge-like vessel which floats in the tank 12. Barge 32 includes a bottom wall 34, a first side wall 36, a second side wall 38, a semi-circular end wall 40 and an open end 41 at the ends 42 and 43 of side walls 36 and 38 respectively. The barge 32 may have other shapes. Barge 32 is comprised of a metal material such as stainless steel, steel, iron, aluminum or other suitable material. Barge 32 is supported in tank 12 by a plurality of upper suspension assemblies 44, 46, 48, 50, 52, 54, 56 and 58 which extend between the barge 32 and the tank 12. Barge 32 is also supported in tank 12 by eight lower suspension assemblies, identical to suspension assemblies 44, 46, 48, 50, 52, 54, 56 and 58, which are positioned below suspension assemblies 44, 46, 48, 50, 52, 54, 56 and 58. The suspension assemblies permit barge 32 to move somewhat with respect to tank 12.

The numeral 59 refers to a nuclear reactor which is positioned in barge 32 so as to close the open end 41 of barge 32. It should be noted that the nuclear reactor 59 may be positioned at any place in barge 32. Reactor 59 includes an upstanding containment member 60 which has a cylindrical body portion 62, a hemi-spherical upper end 64 and a hemi-spherical lower end 66. Containment member 60 is comprised of stainless steel or other suitable material. Containment member 60 is positioned at the open end 41 of barge 32 with the sides of containment member 60 being in engagement with the ends 42 and 43 of side walls 36 and 38 respectively of barge 32 and being secured thereto by welding or the like to close the open end 41 of barge 32. The positioning of the containment member 60 as just described causes the outer side of containment member 60 to be in contact with the water 30 in tank 12. Containment member 60 defines a sealed interior compartment 68.

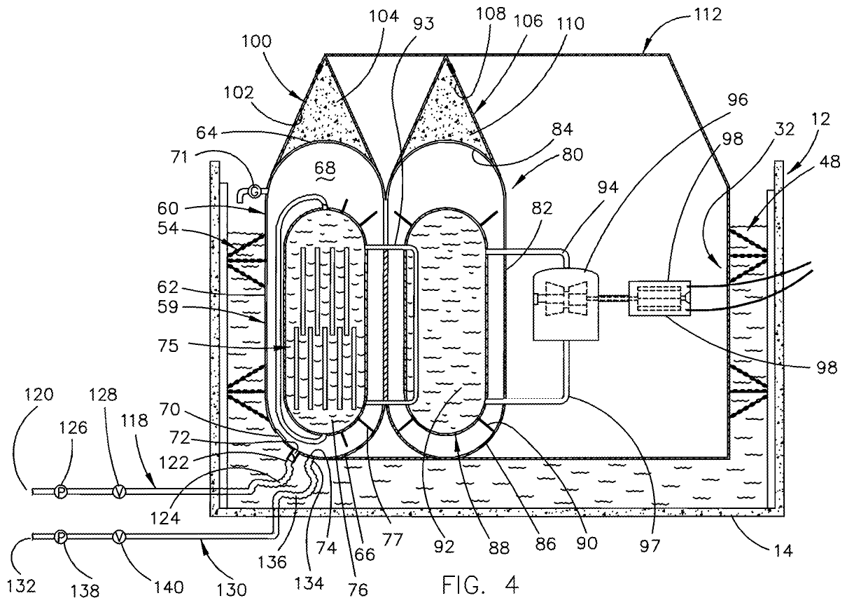

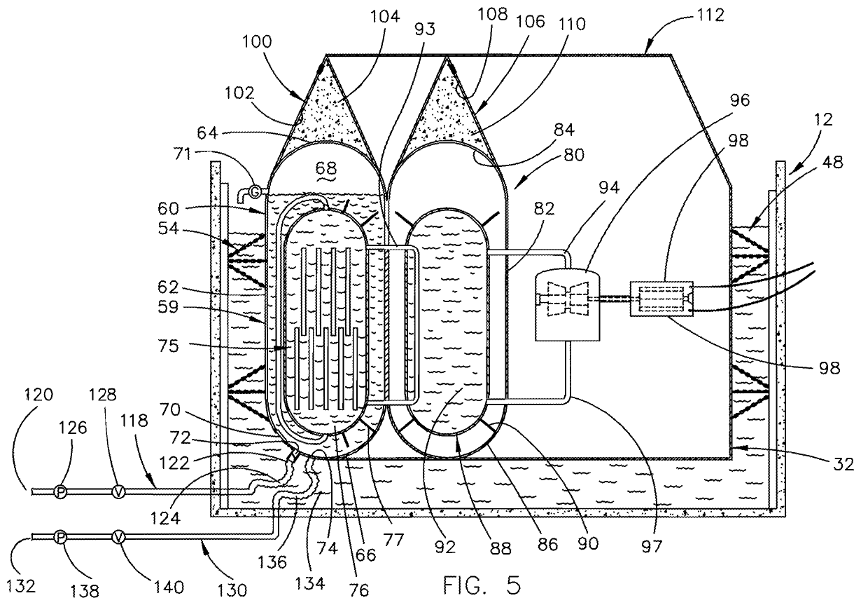

Containment member 60 has a hatch 70 mounted therein as seen in FIGS. 4 and 5. Containment member 60 also has a gate 71 at its upper end. Gate 71 is normally closed. Gate 71 may be manually opened and closed or may be electrically controlled. If electrically controlled, gate 71 may be remotely operated. It is preferred that a plurality of gates 71 be utilized in case of failure of one gate. Containment member 60 also has water inlets 72 and 74 formed therein which are in fluid communication with the sealed interior compartment 68 of containment member 60.

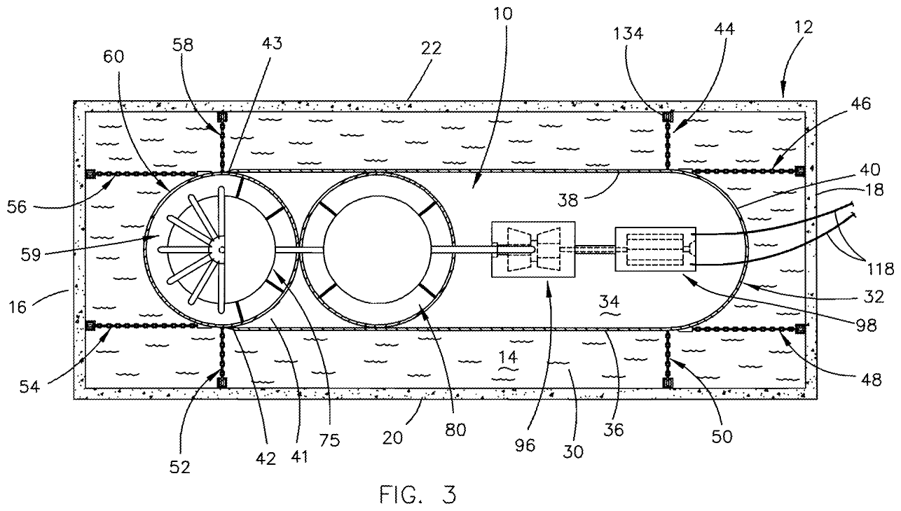

A reactor vessel 75 is positioned in interior compartment 68 and has an interior compartment 76. Vessel 75 is supported in compartment 68 by braces 77 which extend between the exterior of reactor vessel 75 and the interior side of containment member 60 as seen in FIG. 3.

The numeral 80 refers to an upstanding heat exchanger which is positioned adjacent containment member 60 as seen in the drawings. Heat exchanger 80 includes a body section 82, an upper section 84 and a lower section 86. Heat exchanger 80 is comprised of a metal material such as stainless steel or other suitable material. A vessel 88 is positioned within heat exchanger 80 and is supported therein by braces 90 extending therebetween. Vessel 88 defines an interior compartment 92. A tube 93 interconnects the reactor vessel 75 and the vessel 88 of heat exchanger 80 as seen in the drawings. The heat exchanger 80 is connected to a turbine 96 or other device by tube 94 which is connected to a generator 98 or other structure or device. A return line 97 extends from turbine 96 to vessel 88.

Although not a part of the instant invention, a hollow metal cone 100 is mounted on the hemi-spherical upper end 64 of containment member 60. Cone 100 is comprised of stainless steel, steel or other suitable material. Cone 100 has an interior compartment 102 which is preferably filled with a filter material 104 which not only may serve as a filtration bed but serves as an impact absorber should the cone 100 be struck by an aircraft or a missile. The cone 100, if struck by an aircraft or missile, will disintegrate or tear apart the aircraft or missile and deflect the aircraft or missile away from the cone 100.

A metal cone 106, having an interior compartment 108, extends upwardly from the upper end of heat exchanger 80 and may be filled with an impact absorbing material 110. Cone 106, if struck by an aircraft or missile, will disintegrate the aircraft or missile in the same manner as the cone 100.

A roof 112 extends over the cones 100, 106 and the barge 32 to hide the reactor 59 and the heat exchanger 80 from view. Thus, if an aircraft is attempting to strike the reactor 59, the pilot of the aircraft will not be able to determine the exact location of the reactor 59.

The numeral 118 refers to cold water pipe or tube having an inlet end 120 and a discharge end 122. The inlet end 120 of pipe or tube 118 is in communication with a source of cold water. Cold water pipe or tube 118 extends through tank 12 and barge 32 with the discharge end 122 of cold water pipe or tube 118 being in communication with inlet opening 72 and the interior compartment 68 of containment member 60. Although the entire length of cold water pipe or tube 118 is preferably flexible, the cold water pipe or tube 118 has a flexible and slack portion 124 positioned between tank 12 and containment member 60 so that cold water pipe or tube 118 will not break upon barge 32 moving with respect to tank 12. Cold water pipe or tube 118 has an optional pump 126 and a valve 128 imposed therein outwardly of tank 12. The pump 126 and valve 128 may be remotely controlled.

The numeral 130 refers to an optional second cold water pipe or tube having an inlet end 132 and a discharge end 134. The inlet end 132 of cold water pipe or tube 130 is in communication with a source of cold water. Cold water pipe or tube 130 extends through the bottom walls of tank 12 and barge 32 with the discharge end 134 of cold water pipe or tube 130 being in communication with inlet opening 74 on the interior compartment 68 of containment member 60. Although the entire length of cold water pipe or tube 130 is preferably flexible, the cold water pipe or tube 130 has a flexible and slack portion 136 positioned between the bottom walls of tank 12 and barge 32 so that cold water pipe or tube 130 will not break upon barge 32 moving with respect to tank 12. Cold water pipe or tube 130 has an optional pump 138 and valve 140 imposed therein outwardly of tank 12. The pump 138 and valve 140 may be remotely controlled.

In normal operation, the valve 128 in water pipe or tube 118 will be closed. In normal operation, the pump 126 will not be activated and valve 128 will be closed. If an emergency situation arises, pump 126 may be activated and valve 128 will be opened to supply cold water into compartment 68 to cool the reactor vessel 75. Normally, valve 140 will be closed and pump 138 will not be activated. If necessary, the pump 138 in pipe 130 may be activated and valve 140 in pipe 130 will be opened to also supply cold water into compartment 68 to cool the reactor vessel 76.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A floating nuclear reactor, comprising:
a tank having water therein;
a barge floatably positioned in said tank;
a nuclear reactor positioned on said barge;
said reactor including an upstanding containment member having an upper end an a lower end;
said containment member defining an interior compartment;
said reactor including a reactor vessel positioned in said interior compartment of said containment member;
said reactor vessel having an interior compartment;
an elongated cold water tube having an inlet end and an outlet end;
said inlet end of said cold water tube being positioned outwardly of said tank and being in communication with a source of cold water;
said elongated cold water tube extending inwardly through said tank and said barge; and
said outlet end of said cold water tube being in communication with said interior compartment of said containment member.

2. The floating nuclear reactor of claim 1 further including a valve associated with said cold water tube outwardly of said tank.

3. The floating nuclear reactor of claim 2 wherein said valve is controlled from a remote location.

4. The floating nuclear reactor of claim 1 wherein a plurality of cold water tubes are provided for supplying cold water to said interior compartment of said containment member.

5. The floating nuclear reactor of claim 1 wherein said cold water tube is flexible.

6. The floating nuclear reactor of claim 1 wherein said cold water tube includes a flexible and slack portion positioned between said tank and said containment member.

7. The floating nuclear reactor of claim 1 wherein a pump is associated with said cold water tube outwardly of said tank.

8. The floating nuclear reactor of claim 7 wherein said pump is remotely controlled.

9. The floating nuclear reactor of claim 4 wherein each of said cold water tubes includes a flexible and slack portion positioned between said tank and said containment member.

10. The floating nuclear reactor of claim 1 wherein a gate member is positioned adjacent to the upper end of said containment member.

11. The floating nuclear reactor of claim 10 wherein said gate member is normally closed but is movable to an open position.
